(19) United States
(12) Patent Application Publication
(10) Pub. No.: US 2026/0044367 A1
(43) Pub. Date: Feb. 12, 2026

(54) FACILITATING MIGRATION OF SCHEDULER OBJECTS BETWEEN SCHEDULER SYSTEMS

(71) Applicant: Capital One Services, LLC, McLean, VA (US)

(72) Inventors: Gayatri VISHNUBHOTLA, Plano, TX (US); Harsha LAKSHMIKANTHA, Audubon, PA (US); Sweatha BOODIDHI, Frisco, TX (US); Ronald David STIES, Mechanicsville, VA (US); Bruce NGUYEN, San Francisco, CA (US); Krystan R. FRANZEN, Mechanicsville, VA (US); Ananthan SUBRAMANIAM, Tracy, CA (US)

(73) Assignee: Capital One Services, LLC, McLean, VA (US)

(21) Appl. No.: 18/799,652

(22) Filed: Aug. 9, 2024

(51) Int. Cl. G06F 9/48; G06F 16/21

(52) U.S. Cl. CPC G06F 9/4856; G06F 9/4881; G06F 16/212

(57) ABSTRACT

Some implementations described herein relate to a system for migrating scheduler objects between scheduler systems. The system may be configured to obtain a first data structure that includes one or more first scheduler objects that conform to a first schema format that is associated with a first scheduler system. The system may be configured to identify the one or more first scheduler objects included in the first data structure. The system may be configured to generate, based on identifying the one or more first scheduler objects, a second data structure that includes one or more second scheduler objects that conform to a second schema format that is associated with a second scheduler system. The system may be configured to provide the second data structure to the second scheduler system.

### BACKGROUND

A scheduler system manages execution of scheduler objects (e.g., that include jobs and/or workflows). The scheduler system can schedule execution of the scheduler objects to enable, for example, efficient use of computational resources or timely scheduler object completion.

### SUMMARY

Some implementations described herein relate to a system for migrating scheduler objects between scheduler systems. The system may include one or more memories and one or more processors communicatively coupled to the one or more memories. The one or more processors may be configured to obtain a first data structure that includes one or more first scheduler objects that conform to a first schema format that is associated with a first scheduler system. The one or more processors may be configured to identify the one or more first scheduler objects included in the first data structure. The one or more processors may be configured to generate, based on identifying the one or more first scheduler objects, a second data structure that includes one or more second scheduler objects that conform to a second schema format that is associated with a second scheduler system. The one or more processors may be configured to provide the second data structure to the second scheduler system.

Some implementations described herein relate to a non-transitory computer-readable medium that stores a set of instructions. The set of instructions, when executed by one or more processors of a system, may cause the system to obtain a first data structure that includes one or more first scheduler objects that conform to a first schema format that is associated with a first scheduler system. The set of instructions, when executed by one or more processors of the system, may cause the system to generate, based on the first data structure, a second data structure that includes one or more second scheduler objects that conform to a second schema format that is associated with a second scheduler system. The set of instructions, when executed by one or more processors of the system, may cause the system to provide the second data structure to the second scheduler system.

Some implementations described herein relate to a method. The method may include generating, by a system and based on a first data structure that includes one or more first scheduler objects that conform to a first schema format, a second data structure that includes one or more second scheduler objects that conform to a second schema format. The method may include providing, by the system, the second data structure.

### BRIEF DESCRIPTION OF THE DRAWINGS

FIGS. 1A-1D are diagrams of an example implementation associated with facilitating migration of scheduler objects between scheduler systems, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with facilitating migration of scheduler objects between scheduler systems, in accordance with some embodiments of the present disclosure.

FIG. 4 is a flowchart of an example process associated with facilitating migration of scheduler objects between scheduler systems, in accordance with some embodiments of the present disclosure.

### DETAILED DESCRIPTION

The following detailed description of example implementations refers to the accompanying drawings. The same reference numbers in different drawings may identify the same or similar elements.

A scheduler system is configured to schedule execution of scheduler objects that conform to a schema format. In many cases, different scheduler systems are associated with different schema formats. That is, each scheduler system is configured to read, parse, and/or understand scheduler objects that conform to a particular schema format, but not scheduler objects that conform to another schema format. Thus, there is a need, such as when a first scheduler system is to be replaced by a second scheduler system, to migrate scheduler objects that conform to a first schema format to scheduler objects that conform to a second schema format.

A user, or a scheduler system administrator, can reformat a scheduler object that conforms to the first schema format to a scheduler object that conforms to the second schema format. Such a technique involves a significant amount of manual intervention, which is time intensive, inefficient, error-prone, and unscalable, considering that large amounts of scheduler objects (e.g., hundreds, thousands, hundreds of thousands, or more scheduler objects) that may need to be reformatted for a typical scheduler system. Further, such manual reformatting can result in non-optimally reformatted scheduler objects. This often leads to the scheduler objects not being accurately scheduled for execution and/or inefficient use of computing resources (e.g., processing resources, memory resources, communication resources, and/or power resources, among other examples) of the second scheduler system to attempt to schedule execution of the non-optimally reformatted scheduler objects.

Some implementations described herein include a migration system. The migration system obtains a first data structure (e.g., a file, a table, or a database) that includes one or more first scheduler objects that conform to a first schema format (e.g., that would allow the one or more first scheduler objects to be scheduled for execution by a first scheduler system). The migration system generates a second data structure that includes one or more second scheduler objects that conform to a second schema format (e.g., that allows the one or more second scheduler objects to be scheduled for execution by a second scheduler system). Each second scheduler object corresponds to a first scheduler object (e.g., each second scheduler object is a reformatted version of a corresponding first scheduler object). The migration system then provides the second data structure to the second scheduler system to allow the second scheduler system to schedule execution of the one or more second scheduler objects.

In this way, the migration system automatically reformats scheduler objects that conform to a first schema format to a second schema format, which enables the second scheduler system to schedule execution of the scheduler objects (e.g., without manual intervention). Also, the migration system may be configured to optimally reformat the scheduler objects such that a likelihood of the scheduler objects being accurately scheduled for execution is improved and/or such that use of computing resources (e.g., processing resources, memory resources, communication resources, and/or power resources, among other examples) of the second scheduler system to attempt to schedule execution of the optimally reformatted scheduler objects is reduced.

Further, in some implementations, the migration system can cause first scheduler objects that cannot be reformatted to the second schema format to remain included in the first data structure. The migration system can then provide the first data structure to the first scheduler system to ensure that these first scheduler objects are still scheduled for execution (by the first scheduler system). This enables a seamless scheduling of scheduler objects while both the first scheduler system and the second scheduler system are operable.

Additionally, the migration system can identify first scheduler objects that can be reformatted and have respective fulfillment dependencies associated with first scheduler objects that cannot be reformatted (and therefore remain in the first data structure). Accordingly, the migration system can generate, in the second data structure, second scheduler objects that correspond to the identified first scheduler objects, and that include, in each second scheduler object, information that indicates the fulfillment dependency of the corresponding first scheduler object that cannot be reformatted. In this way, the second scheduler system can schedule (e.g., after being provided the second data structure) the second scheduler objects such that the fulfillment dependencies can be satisfied (e.g., as long as the first scheduler accurately schedules execution of the first scheduler objects upon which the fulfillment dependencies rely).

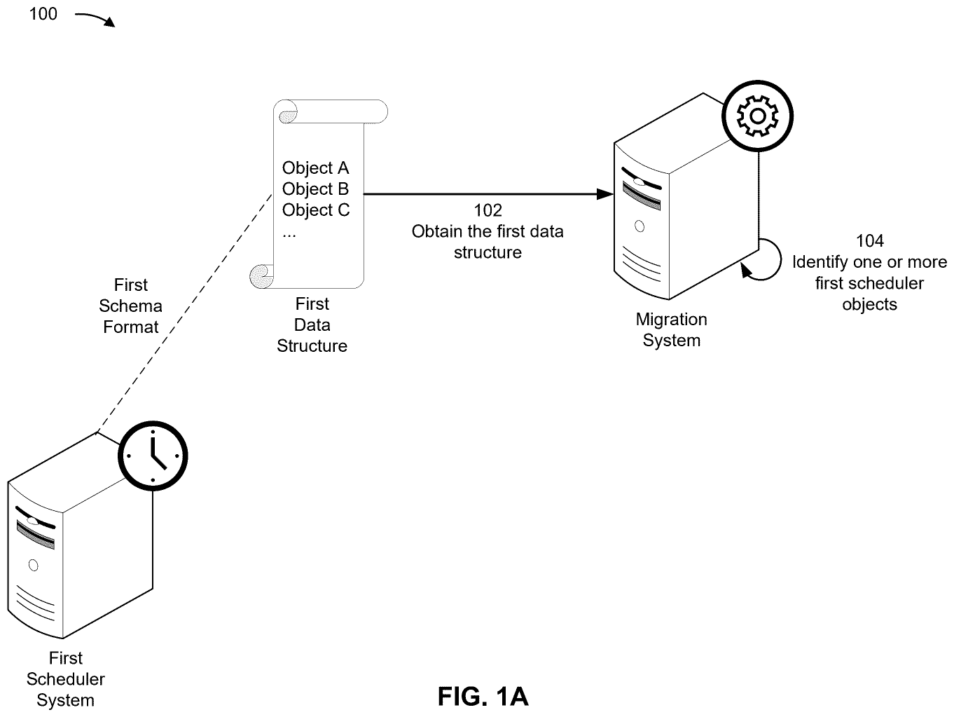

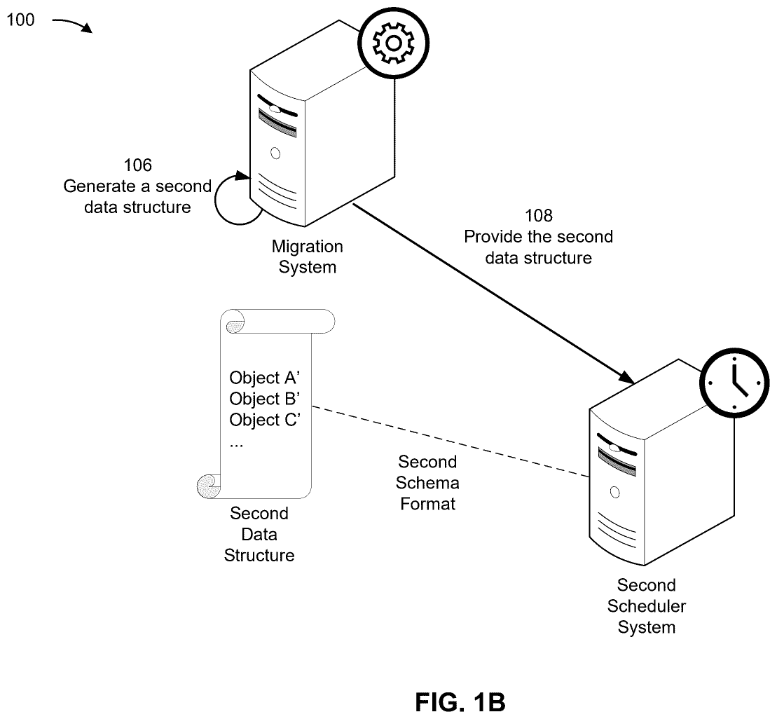

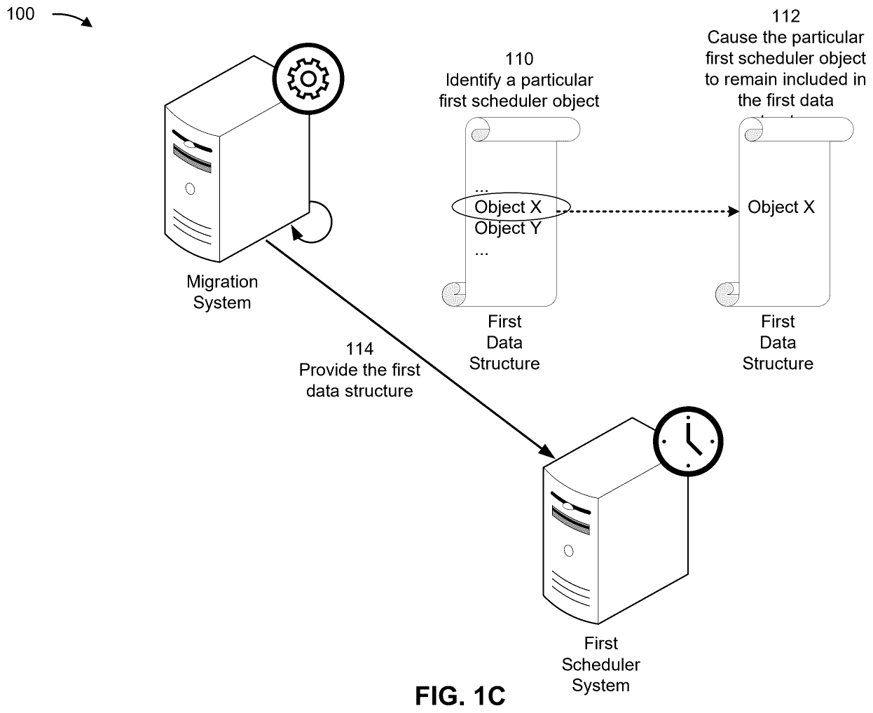

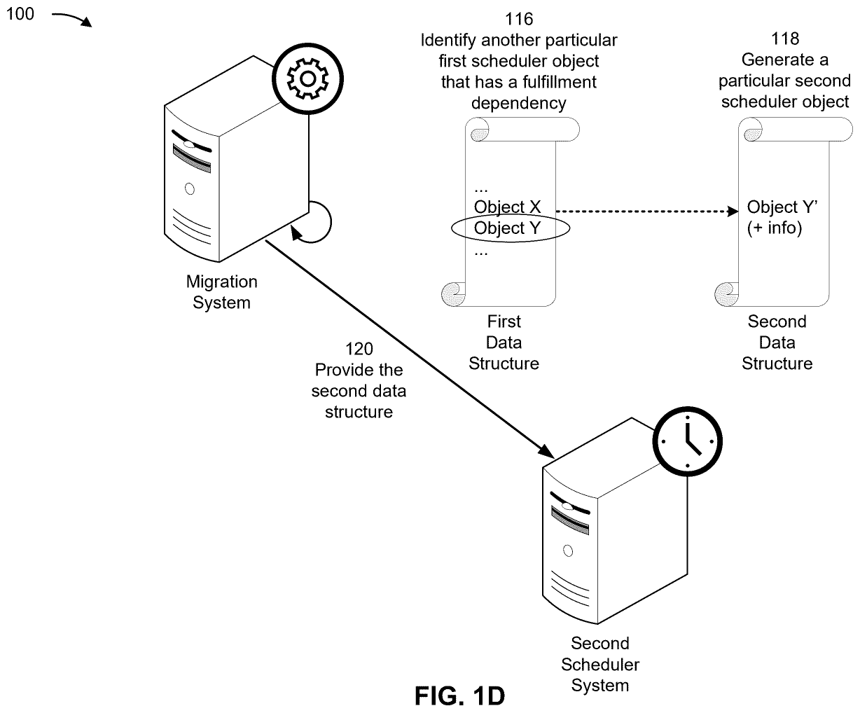

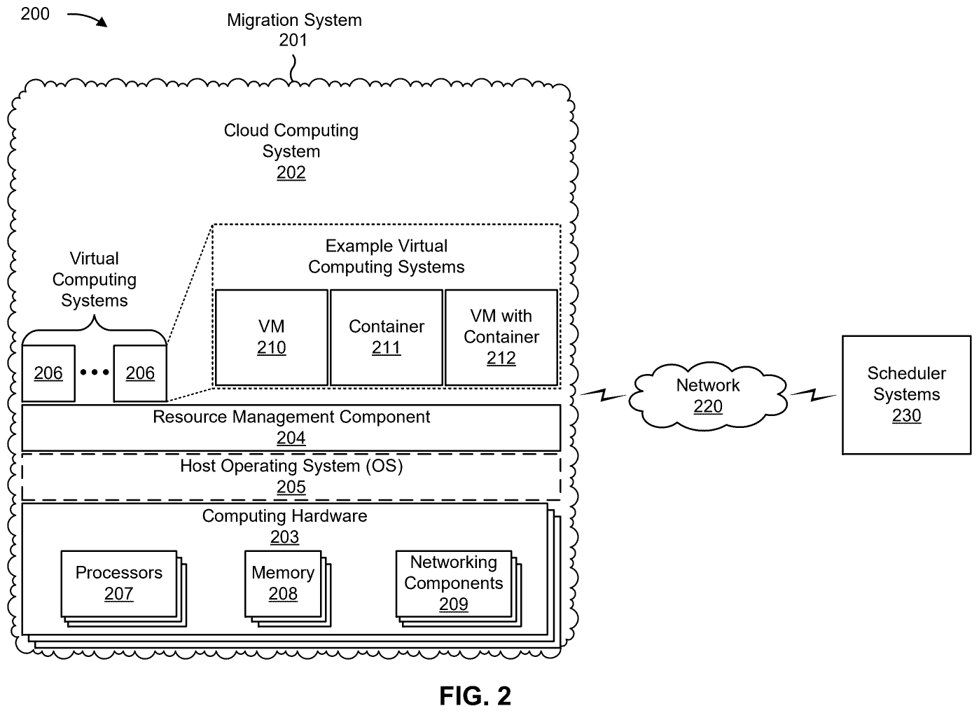

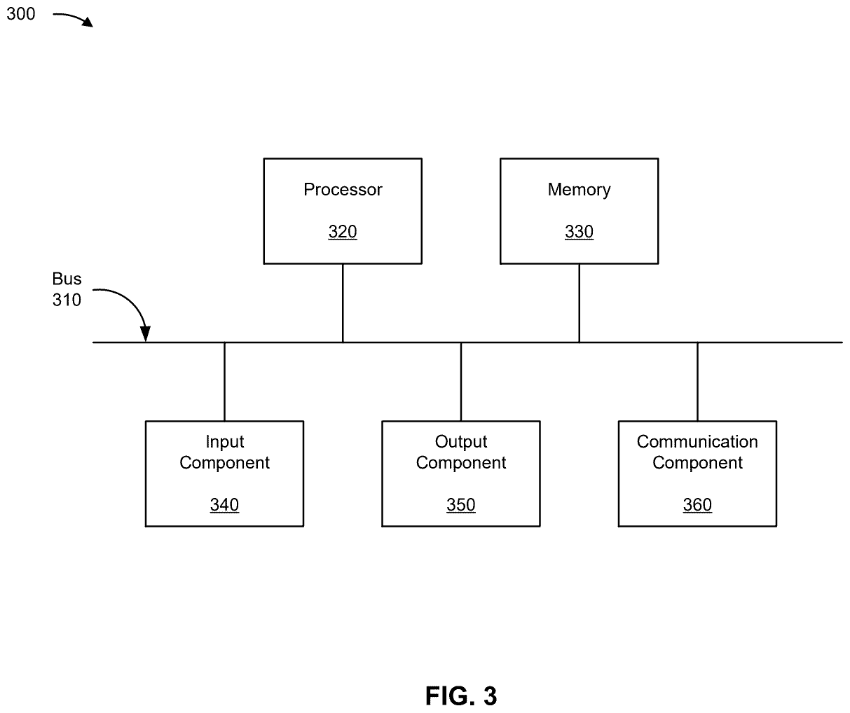

FIGS. 1A-1D are diagrams of an example implementation 100 associated with facilitating migration of scheduler objects between scheduler systems. As shown in FIGS. 1A-1D, example implementation 100 includes a migration system, a first scheduler system, and a second scheduler system. These devices are described in more detail below in connection with FIG. 2 and FIG. 3.

The first scheduler system and the second scheduler system may be configured to schedule execution of scheduler objects (e.g., that each comprise a workflow, a job, and/or calendar, among other examples). The first scheduler system may be associated with a first schema format. That is, scheduler objects that are to be scheduled by the first scheduler need to conform to the first schema format (e.g., to enable accurate scheduling of the scheduler objects by the first scheduler). Additionally, the second scheduler system may be associated with a second schema format (e.g., that is different than the first schema format). That is, scheduler objects that are to be scheduled by the second scheduler need to conform to the second schema format (e.g., to enable accurate scheduling of the scheduler objects by the second scheduler).

As shown in FIG. 1A, and by reference number 102, the migration system may obtain a first data structure. The first data structure may be, for example, a file, a table, a database, or another type of data structure. The first data structure may include one or more first scheduler objects (shown as Object A, Object B, Object C, and so on). A first scheduler object may include at least one of a workflow, a job, or a calendar, among other examples. Further, the one or more first scheduler objects may conform to the first schema format that is associated with the first scheduler system. For example, each first scheduler object may include at least one parameter that conforms to the first schema format (e.g., the at least one parameter has a formatting that can be read, parsed, and/or understood by the first scheduler system).

In some implementations, the migration system may receive the first data structure from another system or device (e.g., to allow the migration system to perform one or more operations related to the first data structure, as described herein). Alternatively, the migration system may retrieve the first data structure from another system or device (e.g., to allow the migration system to perform the one or more operations related to the first data structure).

As shown by reference number 104, the migration system may identify the one or more first scheduler objects. For example, the migration system may process (e.g., read and/or parse) the first data structure to identify the one or more first scheduler objects. Accordingly, the migration system may be configured to understand the first schema format.

As shown in FIG. 1B, and by reference number 106, the migration system may generate a second data structure (e.g., based on identifying the one or more first scheduler objects). The second data structure may be, for example, a file, a table, a database, or another type of data structure. The second data structure may include one or more second scheduler objects (shown as Object A′, Object B′, Object C′, and so on). A second scheduler object may include at least one of a workflow, a job, or a calendar, among other examples. Further, the one or more second scheduler objects may conform to the second schema format that is associated with the second scheduler system. For example, each first scheduler object may include at least one parameter that conforms to the second schema format (e.g., the at least one parameter has a formatting that can be read, parsed, and/or understood by the second scheduler system).

In some implementations, the one or more second scheduler objects respectively correspond to the one or more first scheduler objects. For example, the second scheduler objects shown in FIG. 1B may respectively correspond to the first scheduler objects shown in FIG. 1A. That is, Object A′ may correspond to Object A, Object B′ may correspond to Object B, Object C′ may correspond to Object C, and so on. A second scheduler object may correspond to a first scheduler object by being a reformatted version of the first scheduler object that conforms to the second schema format.

Accordingly, to generate the second data structure, the migration system may identify, for a particular first scheduler object, of the one or more first scheduler objects, a first parameter (of one or more parameters) included in the particular first scheduler object. The first parameter may conform to the first schema format. The migration system then may generate a particular second scheduler object (e.g., that corresponds to the particular first scheduler object), of the one or more second scheduler objects, that includes a second parameter (of one or more parameters) that corresponds to the first parameter. The second parameter may conform to the second schema format. In this way, the migration system may generate one or more parameters of a second scheduler object that respectively correspond to one or more parameters of a first scheduler object and that conform to the second schema format. The migration system may thereby generate the second data structure to include one or more second scheduler objects, where each second scheduler object includes one or more parameters that respectively correspond to one or more parameters of a first scheduler object, and each second scheduler object conforms to the second schema format.

As shown by reference number 108, the migration system may provide the second data structure. For example, the migration system may provide the second data structure to the second scheduler system (e.g., by sending the second data structure to the second scheduler system). This allows, or enables, execution of the one or more second scheduler objects to be scheduled. For example, the second scheduler system may schedule execution of the one or more second scheduler objects (e.g., because the one or more second scheduler objects conform to the second schema format). As a specific example, the second scheduler system may schedule Object A′, Object B′, Object C′, and so on, of the second data structure shown in FIG. 1B.

As shown in FIG. 1C, and by reference number 110, the migration system may identify (e.g., in association with identifying the one or more first scheduler objects, as described herein in relation to FIG. 1A and reference number 104, and/or in association with generating the second data structure, as described herein in relation to FIG. 1B and reference number 106) a particular first scheduler object, of the one or more first scheduler objects, for which a corresponding second scheduler object is not able to be generated. For example, the particular first scheduler object may include one or more parameters that are not supported by the second schema format and/or the particular first scheduler object may provide a functionality that is not supported by the second scheduler system.

In some implementations, as part of generating a second data structure, when a second scheduler object is generated that corresponds to a first scheduler object of the first data structure, the migration system may remove the first scheduler object from the first data structure. Notable, here, as shown by reference number 112, the migration system may cause (e.g., because a corresponding second scheduler object is not able to be generated) the particular first scheduler object to remain included in the first data structure (e.g., to not be removed from the first data structure). Thus, any first scheduler object that remains included in the first data structure, after generation of the second data structure is complete, is a first scheduler object that does not have a corresponding second scheduler object included in the second data structure.

In a specific example, as shown in FIG. 1C, the migration system may identify Object X in the first data structure (e.g., as a first scheduler object for which a corresponding second scheduler object is not able to be generated). Accordingly, as further shown in FIG. 1C, the migration system may cause Object X to remain included in the first data structure (and may remove an Object Y from the first data structure because a corresponding second scheduler object is able to be generated for Object Y).

As shown by reference number 114, the migration system may provide the first data structure (e.g., after removing first scheduler objects from the first data structure that have corresponding second scheduler objects, and after causing first scheduler objects for which corresponding second scheduler objects are not able to be generated to remain included in the first data structure). For example, the migration system may provide the first data structure to the first scheduler system (e.g., by sending the first data structure to the first scheduler system). This allows, or enables, execution of at least one first scheduler object that is included in the first data structure to be scheduled. For example, the first scheduler system may schedule execution of the at least one first scheduler object (e.g., because the at least one first scheduler object conforms to the first schema format). As a specific example, the first scheduler system may schedule Object X shown in FIG. 1C.

As shown in FIG. 1D, and by reference number 116, the migration system may identify (e.g., in association with identifying the one or more first scheduler objects, as described herein in relation to FIG. 1A and reference number 104, in association with generating the second data structure, as described herein in relation to FIG. 1B and reference number 106, and/or in association with identifying a particular first scheduler object for which a corresponding second scheduler object is not able to be generated, as described herein in relation to FIG. 1C and reference number 110) another particular first scheduler object, of the one or more first scheduler objects, for which a corresponding second scheduler object is able to be generated. Additionally, the migration system may determine that the other particular first scheduler object has a fulfillment dependency associated with the particular first scheduler object (e.g., that remains in the first data structure). That is, the other particular first scheduler object may need to commence after commencement and/or completion of execution of the particular scheduler object (or may have another type of fulfillment dependency). As a specific example, as shown in FIG. 1D, the migration system may identify Object Y as a first scheduler for which a corresponding second scheduler object is able to be generated, and may determine that Object Y has a fulfillment dependency associated with Object X (e.g., that remains in the first data structure because a corresponding second scheduler object is not able to be generated for Object X).

Accordingly, as shown by reference number 118, the migration system may generate a particular second scheduler object, of the one or more second scheduler objects, that corresponds to the other particular first scheduler object and that includes information indicating the fulfillment dependency. As a specific example, as shown in FIG. 1D, the migration system may generate Object Y′ as a second scheduler object that corresponds to Object Y and that includes information indicating the fulfillment dependency associated with Object X.

As shown by reference number 120, the migration system may provide the second data structure (e.g., in a same or similar manner as that described herein in relation to FIG. 1B and reference number 108). For example, the migration system may provide the second data structure to the second scheduler system (e.g., by sending the second data structure to the second scheduler system). This allows, or enables, execution of the particular second scheduler object (e.g., that has a fulfillment dependency with a particular first scheduler object that remains in the first data structure) to be scheduled. For example, the second scheduler system may schedule execution of the particular second scheduler object such that the fulfillment dependency can be satisfied (e.g., as long as a first scheduler accurately schedules execution of the particular first scheduler object). For example, the second scheduler system may schedule execution of the particular second scheduler object with a delay indicated by the information included in the particular second scheduler object. As a specific example, the second scheduler system may schedule Object Y′, of the second data structure shown in FIG. 1D, with a delay such that execution of Object Y′ commences after commencement and/or completion of execution of the Object X (e.g., as scheduled by the first scheduler system).

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods described herein may be implemented. As shown in FIG. 2, environment 200 may include a migration system 201, which may include one or more elements of and/or may execute within a cloud computing system 202. The cloud computing system 202 may include one or more elements 203-212, as described in more detail below. As further shown in FIG. 2, environment 200 may include a network 220, and a plurality of scheduler systems 230. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the migration system 201 may include one or more elements 203-212 of the cloud computing system 202, may execute within the cloud computing system 202, and/or may be hosted within the cloud computing system 202, in some implementations, the migration system 201 may not be cloud-based (e.g., may be implemented outside of a cloud computing system) or may be partially cloud-based. For example, the migration system 201 may include one or more devices that are not part of the cloud computing system 202, such as device 300 of FIG. 3, which may include a standalone server or another type of computing device. The migration system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The scheduler system 230 may include one or more devices capable of receiving, generating, storing, processing, providing, and/or routing information, as described elsewhere herein. The scheduler system 230 may include a communication device and/or a computing device. For example, the scheduler system 230 may include a server, such as an application server, a client server, a web server, a database server, a host server, a proxy server, a virtual server (e.g., executing on computing hardware), or a server in a cloud computing system. In some implementations, the scheduler system 230 may include computing hardware used in a cloud computing environment. The scheduler system 230 may be configured to schedule execution of scheduler objects included in a data structure (e.g., when the scheduler objects conform to a schema format associated with the scheduler system 230).

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with facilitating migration of scheduler objects between scheduler systems. The device 300 may correspond to the migration system 201, the computing hardware 203, and/or the scheduler system 230. In some implementations, the migration system 201, the computing hardware 203, and/or the scheduler system 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

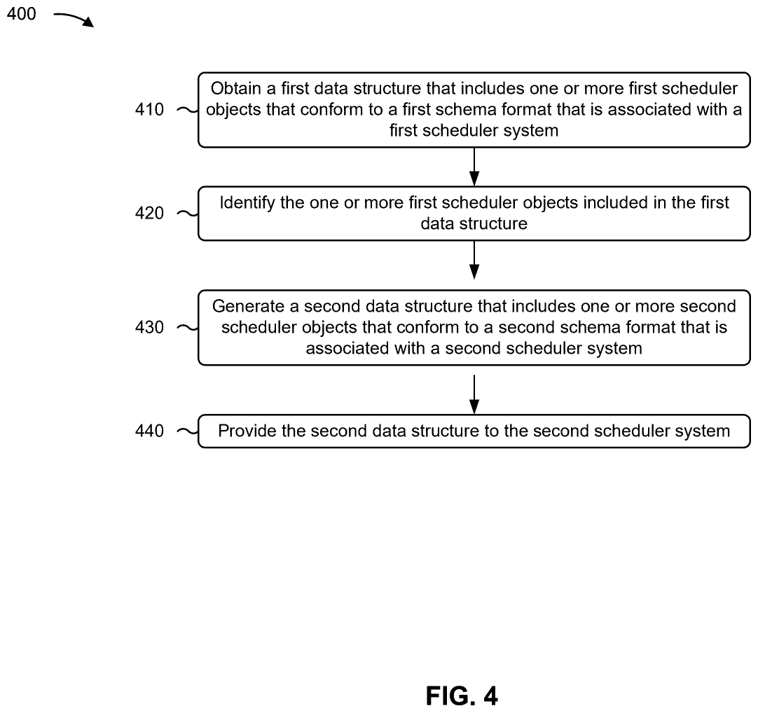

FIG. 4 is a flowchart of an example process 400 associated with facilitating migration of scheduler objects between scheduler systems. In some implementations, one or more process blocks of FIG. 4 may be performed by the migration system 201. In some implementations, one or more process blocks of FIG. 4 may be performed by another device or a group of devices separate from or including the migration system 201, such as the computing hardware 203, and/or the scheduler system 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a first data structure that includes one or more first scheduler objects that conform to a first schema format that is associated with a first scheduler system (block 410). For example, the migration system 201 (e.g., using processor 320, memory 330, input component 340, output component 350, and/or communication component 360) may obtain a first data structure that includes one or more first scheduler objects that conform to a first schema format that is associated with a first scheduler system, as described above in connection with reference number 102 of FIG. 1A. As an example, may receive the first data structure from another system or device.

As further shown in FIG. 4, process 400 may include identifying the one or more first scheduler objects included in the first data structure (block 420). For example, the migration system 201 (e.g., using processor 320 and/or memory 330) may identify the one or more first scheduler objects included in the first data structure, as described above in connection with reference number 104 of FIG. 1A. As an example, the migration system 201 may process (e.g., read and/or parse) the first data structure to identify the one or more first scheduler objects.

As further shown in FIG. 4, process 400 may include generating, a second data structure that includes one or more second scheduler objects that conform to a second schema format that is associated with a second scheduler system (block 430). For example, the migration system 201 (e.g., using processor 320 and/or memory 330) may generate, based on identifying the one or more first scheduler objects, a second data structure that includes one or more second scheduler objects that conform to a second schema format that is associated with a second scheduler system, as described above in connection with reference number 106 of FIG. 1B. As an example, the migration system 201 may generate the second data structure to include one or more second scheduler objects that respectively correspond to the one or more first scheduler objects of the first data structure.

As further shown in FIG. 4, process 400 may include providing the second data structure to the second scheduler system (block 440). For example, the migration system 201 (e.g., using processor 320 and/or memory 330) may provide the second data structure to the second scheduler system, as described above in connection with reference number 108 of FIG. 1B. As an example, the migration system 201 may send the second data structure to the second scheduler system.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c”is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z. ”

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for migrating scheduler objects between scheduler systems, the system comprising:
one or more memories; and
one or more processors, communicatively coupled to the one or more memories, configured to:
obtain a first data structure that includes one or more first scheduler objects that conform to a first schema format that is associated with a first scheduler system;
identify the one or more first scheduler objects included in the first data structure;
generate, based on identifying the one or more first scheduler objects, a second data structure that includes one or more second scheduler objects that conform to a second schema format that is associated with a second scheduler system; and
provide the second data structure to the second scheduler system.

2. The system of claim 1, wherein the one or more processors, to generate the second data structure, are configured to:
identify, for a particular first scheduler object, of the one or more first scheduler objects, a first parameter included in the particular first scheduler object that conforms to the first schema format; and
generate a particular second scheduler object, of the one or more second scheduler objects, that corresponds to the particular first scheduler object and that includes a second parameter that conforms to the second schema format and that corresponds to the first parameter.

3. The system of claim 1, wherein a first scheduler object, of the one or more first scheduler objects, includes at least one of:
a workflow;
a job; or
a calendar.

4. The system of claim 1, wherein providing the second data structure to the second scheduler system allows the second scheduler system to schedule execution of the one or more second scheduler objects.

5. The system of claim 1, wherein the one or more second scheduler objects respectively correspond to the one or more first scheduler objects.

6. The system of claim 1, wherein the one or more processors are further configured to:
identify a particular first scheduler object, of the one or more first scheduler objects, for which a corresponding second scheduler object is not able to be generated;
cause the particular first scheduler object to remain included in the first data structure; and
provide the first data structure to the first scheduler system.

7. The system of claim 6, wherein providing the first data structure to the first scheduler system enables the first scheduler system to schedule execution of the particular first scheduler object.

8. The system of claim 6, wherein the one or more processors, to generate the second data structure, are configured to:
identify another particular first scheduler object, of the one or more first scheduler objects, for which a corresponding second scheduler object is able to be generated;
determine that the other particular first scheduler object has a fulfillment dependency associated with the particular first scheduler object; and
generate a particular second scheduler object, of the one or more second scheduler objects, that includes information indicating the fulfillment dependency and that corresponds to the other particular first scheduler object.

9. A non-transitory computer-readable medium storing a set of instructions, the set of instructions comprising:
one or more instructions that, when executed by one or more processors of a system, cause the system to:
obtain a first data structure that includes one or more first scheduler objects that conform to a first schema format that is associated with a first scheduler system;
generate, based on the first data structure, a second data structure that includes one or more second scheduler objects that conform to a second schema format that is associated with a second scheduler system; and
provide the second data structure to the second scheduler system.

10. The non-transitory computer-readable medium of claim 9, wherein the one or more instructions, that cause the system to generate the second data structure, cause the system to:
generate a particular second scheduler object, of the one or more second scheduler objects, that corresponds to a particular first scheduler object, of the one or more first scheduler objects,
wherein a parameter of the particular second scheduler object corresponds to a parameter of the particular first scheduler object.

11. The non-transitory computer-readable medium of claim 9, wherein providing the second data structure to the second scheduler system allows execution of the one or more second scheduler objects to be scheduled.

12. The non-transitory computer-readable medium of claim 9, wherein the one or more second scheduler objects respectively correspond to the one or more first scheduler objects.

13. The non-transitory computer-readable medium of claim 9, wherein the one or more instructions further cause the system to:
cause a particular first scheduler object to remain included in the first data structure; and
provide the first data structure to the first scheduler system.

14. The non-transitory computer-readable medium of claim 13, wherein providing the first data structure to the first scheduler system allows execution of the particular first scheduler object to be scheduled.

15. The non-transitory computer-readable medium of claim 13, wherein the one or more instructions, that cause the system to generate the second data structure, cause the system to:
determine that another particular first scheduler object has a fulfillment dependency associated with the particular first scheduler object; and
generate a particular second scheduler object, of the one or more second scheduler objects, that includes information indicating the fulfillment dependency and that corresponds to the other particular first scheduler object.

16. A method, comprising:
generating, by a system and based on a first data structure that includes one or more first scheduler objects that conform to a first schema format, a second data structure that includes one or more second scheduler objects that conform to a second schema format; and
providing, by the system, the second data structure.

17. The method of claim 16, wherein providing the second data structure includes providing the second data structure to a scheduler system associated with the second schema format.

18. The method of claim 16, wherein the one or more second scheduler objects respectively correspond to the one or more first scheduler objects.

19. The method of claim 16, further comprising:
causing a particular first scheduler object, of the one or more first scheduler objects, to remain included in the first data structure; and
providing the first data structure.

20. The method of claim 19, wherein generating the second data structure comprises:
generating a particular second scheduler object, of the one or more second scheduler objects, that includes information indicating a fulfillment dependency associated with the particular first scheduler object.
